(19) United States
(12) Patent Application Publication
(10) Pub. No.: US 2007/0003397 A1
(43) Pub. Date: Jan. 4, 2007

(54) In-vehicle transport system

(76) Inventors: Edward M. Hirschman, Princeton, NJ (US); Beth S. Hirschman, Princeton, NJ (US)

Correspondence Address: DIEHL SERVILLA LLC, 77 BRANT AVE, SUITE 110, CLARK, NJ, 07066, US

(21) Appl. No.: 11/174,116

(22) Filed: Jul. 1, 2005

(51) Int. Cl. B60P 9/00

(52) U.S. Cl. 414/462

(57) ABSTRACT

An in-vehicle transportation system includes a track that defines a path through the vehicle, a mover that moves along the track, and a caddy that is connected to the mover and which is used to carry items. The track may be mounted adjacent the roof of the vehicle. The track may have stop indicators, which may be user-definable, to indicate positions where the mover should stop along the track. The caddy may be provided an extension mechanism that raises and lowers the caddy so that the items are easier to retrieve.

### BACKGROUND

Vehicle occupants, including, but not limited to parents and children, are often handing items back and forth to each other in a vehicle. These items may include, for example, food, empty food wrappers and containers, toys, tissues, napkins, straws, snacks, fruit, games, etc. As smaller children should be secured in booster seats, and as the parents and larger children are similarly restrained by seat belts, the handing of items back and forth usually requires that a parent, a child or both unbuckle their safety belts, which can be both inconvenient and potentially unsafe. In larger vehicles, especially those with three or more rows of seating, one cannot simply lean over to pass the items, as the distance between the respective passengers is too great. The items can be thrown, but this is potentially dangerous or messy, and often results in the item being dropped, lost or broken. Hence, one of the occupants must get out of his or her seat and move towards the other—if there is an aisle, and if the seatbelt can be safely unfastened. Alternatively, the vehicle must be stopped, and one of the passengers must physically exit the vehicle to pass the item to the other passenger. This is extremely inconvenient, especially during inclement weather, or when in areas where one would prefer not to leave the car for safety reasons.

It is therefore desirable to provide an in-vehicle transport system to alleviate the aforementioned problems, which enables passengers to conveniently and safely pass items to each other without needing to move from their seats or unfasten their seatbelts.

### SUMMARY

Embodiments of the present invention provide an in-vehicle transport system designed to move items safely between passengers. The system may be permanently installed in a vehicle as a factory option, or it may be installed as a dealer option or an after market add-on. The system comprises a track, a mover, a caddy, a user control and control logic.

In one embodiment, the track is installed in, on or adjacent to the inside of the roof, for example, adjacent the roof liner or headliner of a vehicle. As used herein, the terms roof liner or headliner refer to the underside of the vehicle roof, regardless of whether the underside contains material other than the vehicle roof material. Typically, however, the headliner is made from a fabric, leather or plastic material. For purposes of the present invention, the region adjacent to the roof liner or headliner of a vehicle includes those regions of the interior of the vehicle that are between the windows and the ceiling of the vehicle. The track may have a multitude of configurations, including U-shaped, parabolic, question mark-shaped, zigzagged or straight. The track defines the path along which the mover and caddy travel. The track may be flush or recessed with respect to the roof liner or headliner so that headroom is not reduced by the presence of the system, or may be mounted on or adjacent to the roof liner or headliner. Of course, for purposes of the present invention, the roof liner or headliner is also intended to include the internal surface of the roof for vehicles that may have no roof liner or headliner. The track may be made of rigid or flexible material in order to accommodate a variety of vehicle types, track paths and installation scenarios, and may be installed by a vehicle manufacturer, the vehicle owner, the vehicle dealer or an after market supplier. The track may be connected to the vehicle's electrical system to provide power for the mover, and may be designed to ensure that the mover does not detach unless an operator intentionally tries to remove it. The track may be reconfigurable to allow the path to be modified to accommodate after-market changes to the vehicle, such as the installation of an in-ceiling video system.

The mover may be attached to the track, and is designed to move along the track. In one embodiment, the mover may use a motor or equivalent technology to motivate the mover along the track. The motor may be installed on the mover, or be external to the mover. In one embodiment, the mover is small, yet sized to support the weight of the typical items to be moved within the vehicle, and moves at an appropriate speed along the track, i.e., a speed that is not so slow as to frustrate the passenger while waiting for the item to be delivered, nor so fast as to risk colliding with or startling passengers or dropping items from the caddy. The mover may be flush with the track. The mover may be removable from the track for maintenance. The mover may have a connector that enables the caddy to be securely attached to the mover. In one embodiment, the caddy may be connected to a retractable connector that allows the caddy to be raised up to avoid hitting seatbacks and headrests, and lowered down to be within the grasp of smaller children or passengers who cannot reach the caddy when the connector is in the retracted position.

The caddy is used to hold the items to be moved. The caddy is attached to the mover, and in one embodiment, it is detachable to facilitate cleaning of the caddy. The caddy can come in a variety of shapes, sizes and materials to meet the functional and stylistic needs of the vehicle operator. For example, the caddy may be made from a mesh net, a hook, a clamp, a plastic tray with cup holders, etc. Caddies can be simple and functional, or elaborate and ornate, decorated with sports logos or cartoon characters. The caddy may be designed to allow the vehicle occupants to easily add and remove items without leaving their seats or unbuckling their seat belts, and without dropping or spilling the items that go into the caddy. In certain embodiments, the caddy may be open or sealable using a zipper, Velcro, an articulated cover, etc. The caddy does not need to be detached from the mover to add items to the caddy, or to remove items from the caddy. In one embodiment, the caddy may be attached/detached from the mover for maintenance or cleaning, or when no longer needed. The caddy may hang from the mover, enabling the vehicle occupants to add or remove items without unbuckling their seat belts. In another embodiment, the caddy may be secured out of the way when not in use without disconnecting it from the mover, for example, by providing a collapsible caddy.

In one or more embodiments, control logic may be provided to keep track of the current position of the mover, and to control the motor to move the mover to, and stop at preset positions along the track. These preset positions are referred to herein as stops, and may include the terminal ends of the track, as well as points between the terminal ends. In one embodiment, the stops may be user-defined, either mechanically, electronically or in software. According to certain embodiments, the control logic causes the mover to move between stops, and may optionally cause the mover to skip one or more stops. In one embodiment, the control logic knows the number of stops along the track and where the stops are located. In certain embodiments, the control logic receives commands from the user control and attempts to fulfill these commands. In one embodiment, if the commands cannot be fulfilled, the control logic may return an error message, such as an audible tone. The control logic may be contained in a dedicated logic device (suitable for after market installation) or may be integrated into an onboard computer provided by the vehicle manufacturer.

According to one or more embodiments, the stops are predefined positions along the track where the caddy comes to rest so that a passenger can place items in the caddy or remove items therefrom. In one embodiment, a stop may be located near the driver and another stop located near one of the passengers in an intermediate row or rear row of seats. There may be many stops along the track, especially for larger vehicles. Stops may be defined by the manufacturer and may also be redefined by the vehicle operator.

In some embodiments, the user control may include an interface with buttons that the vehicle occupants can press to indicate which stop they want the mover/caddy to move to. In one embodiment, the user control may be installed next to the driver. In one embodiment, multiple sets of controls may be installed, especially for larger vehicles. In another embodiment, the controls may be installed in the center of the front console so that both the driver and front seat passenger can use the same user control. The controls may determine the direction of movement (towards the driver or away) of the mover, and may be designed to indicate if the mover should move to the next stop or to the farthest stop. The user controls may be waterproof, and may provide tactile feedback when pressed so that the user knows that the caddy has been activated or deactivated to reach the intended passenger.

In one embodiment, the system may also include an audible alert device to play an audio signal (a beep, etc.) when the control logic cannot fulfill a command sent from the user control. Examples of this may include a request to move the caddy closer to the driver when the caddy is already at the closest stop to the driver. The audible alert device may be an onboard speaker provided by the vehicle manufacturer (such as a speaker that serves other functions, such as making a sound when the lights are left on), or a dedicated speaker provided to support after-market installations.

### BRIEF DESCRIPTION OF THE DRAWINGS

FIG. 1 is a top view showing an in-vehicle transport system according to a first embodiment;

FIG. 2 is a side view of a system shown together with a seat;

FIG. 3 a side view showing a caddy and a portion of a track according to one embodiment;

FIG. 4 is an end view showing a caddy and a portion of a track according to one embodiment;

FIG. 5 is an end view of a transport system according to a second embodiment;

FIG. 6 is an end view of a transport system according to a third embodiment;

FIG. 7 is a side view of a portion of a transport system according to a fourth embodiment;

FIG. 8 is an end view of the transport system shown in FIG. 7;

FIG. 9 is a side view of a mover, caddy and extension of a transport system according to a fifth embodiment;

FIG. 10 is side view of a mover, caddy and extension of a transport system according to a sixth embodiment;

FIG. 11 is a top view of transport system according to a seventh embodiment;

FIG. 12 is an end view of a transport system according to an eighth embodiment; and

FIG. 13 is a block diagram of control logic presented in FIG. 12.

### DETAILED DESCRIPTION

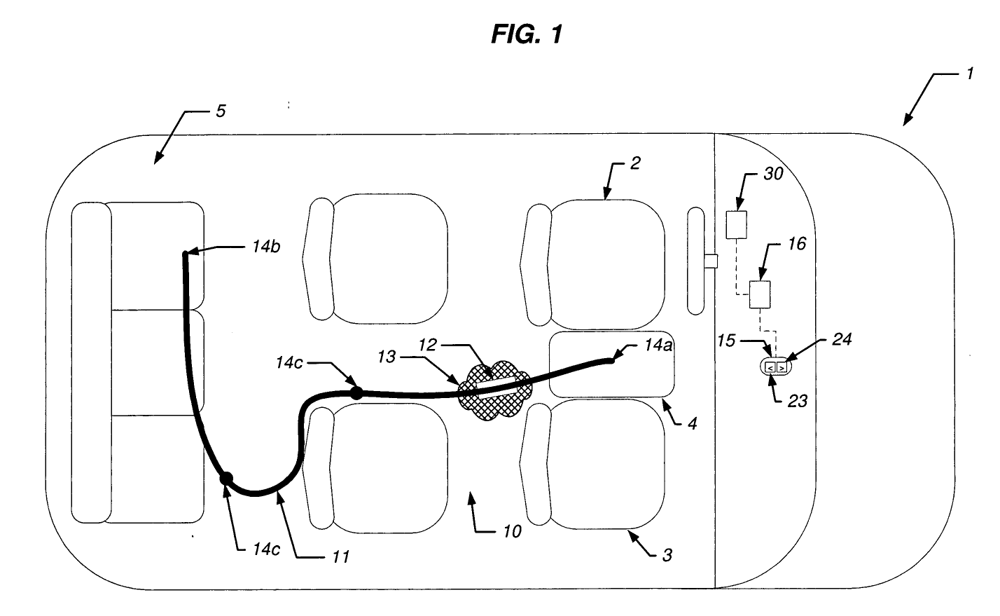

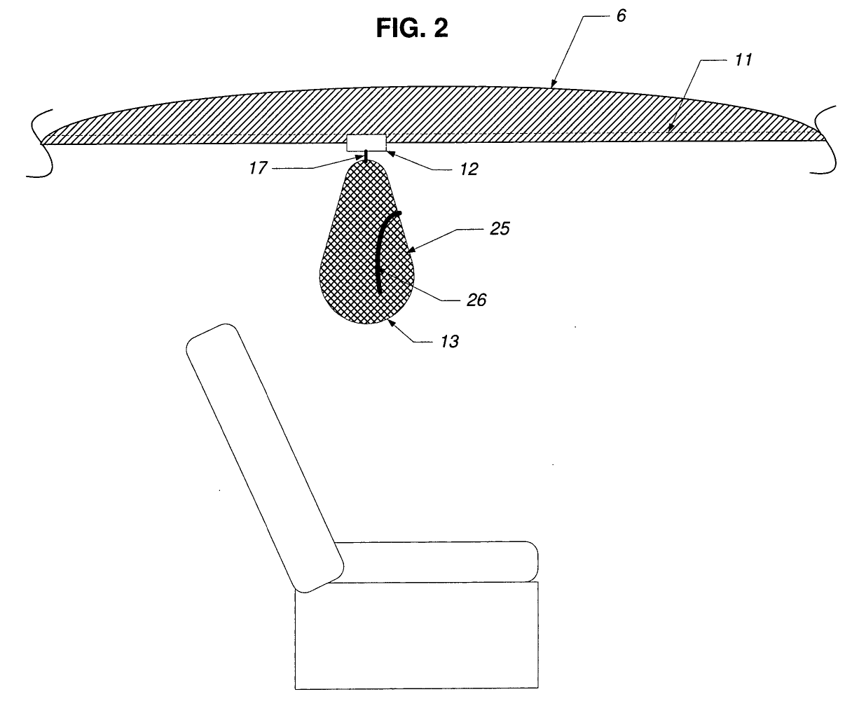

Several exemplary embodiments of the present invention are disclosed herein. It should be understood, however, that the disclosed embodiments are merely exemplary of the invention, which may be embodied in many forms. Therefore, the details disclosed herein are not to be interpreted as limiting, but merely as the basis for claims and as a basis for teaching one skilled in the art how to make and/or use the invention. Referring first to FIG. 1 and FIG. 2, which illustrate a first embodiment of a transport system 10 according to the present invention, the system is shown as installed in a vehicle 1. The system shown in FIG. 1 includes a track 11, a mover 12 and a caddy 13. The track 11 defines the path of the caddy 13 through the vehicle 1 to deliver items to passengers. The mover 12 is designed to mechanically interface with the track 11 to drive the caddy 13 along the path defined by the track 11. In the embodiment depicted in FIGS. 1 and 2, this means that the mover 12 is movably disposed on the track 11, with the caddy 13 connected to the mover 12. In the embodiment shown, the mover 12 is adapted to move along the track 11 and can stop at a beginning stop 14a, an end stop 14b, or a stop 14c in between as directed by a user control 15. Additional stops 14c may be provided that generally correspond with the location of vehicle passengers.

The mover 12 can be any suitable mechanism that interfaces with the track 11 to move the caddy 13 along the track 11. For example, if the track 11 is a rail system, the mover 12 may include one or more rollers or wheels that roll along the track 11. Alternatively, the mover 12 may include gears that mesh with indentations or other features on the track 11. As yet another alternative, the mover 12 may be an arm that attaches to a moving element of the track 11. The mover 12 can be separate from the caddy 13, or it can be integrated with the caddy 13. For example, the caddy 13 may comprise a box-like structure with an upper extension or arm that has a roller, wheel, gear or clasp associated with the extension that is adapted to interface with the track 11.

As shown in FIG. 1, the user control 15 may be mounted between a driver seat 2 and a front passenger seat 3, so that both the driver and a front passenger may have easy access to the user control 15. The user control 15 sends control signals to control logic 16, which controls the mover 12, causing the mover 12 to move forward or backwards along the path defined by the track 11. In certain embodiments, the user control 15 has an “away” rocker button 23 to indicate that the mover 12 should glide away from the operator, and a “home” rocker button 24 to indicate that the mover 12 should glide towards the operator. By pressing and briefly holding the “away” button 23, the mover 12 is sent to the end stop 14b via the control logic 16. By pressing and briefly holding the “home” button 24, the mover is sent to the beginning stop 14a via the control logic 16. Multiple momentary clicks of the buttons 23, 24 will cause the control logic 16 to send the mover 12 forward or backward, which may stop along the track 11. For example, two clicks of the “home” button 24 will cause the mover 12 to advance forward by two stops 14c along the track 11. The user control 15 may be waterproof, and may give tactile feedback when pressed.

Any suitable electronics known to those of skill in the art may be used to implement the control logic 16 to process the signals sent by the user control 15, such as a programmable logic array, a microcontroller, or the like. The control logic 16 may be a dedicated device for the system 10, as provided by an after market add-on option for the vehicle 1, and may be built into the user control 15 or even into the track 11. However, vehicles often contain numerous electronics packages that monitor the status of the vehicle 1, and provide other user services (such as GPS systems). Many of these other electronics packages are suitably flexible and powerful enough to handle the control functionality of the control logic 16. Hence, it should be clear that the control logic 16 may also be served by a multi-purpose logic system provided by the vehicle manufacturer. It should be appreciated that complex control logic 16 is not required of the present invention; at its most basic level, the control logic 16 may do little more than direct the mover 12 to move forward, backward or stop according to the status of the buttons 23, 24 as pressed by a user.

A speaker 30 may be connected to the control logic 16 to provide audible feedback to the user. For example, when the control logic 16 is unable to fulfill a command received from the user control 15, the control logic 16 may cause the speaker 30 to sound a corresponding error tone, as when requesting the mover 12 to move beyond the end point stops 14a, 14b. Similarly, when the control logic 16 detects that the mover 12 has arrived at a desired stop 14a-14c, the control logic 16 may cause the speaker 30 to emit a signal indicating that the caddy 13 has arrived at its desired location. The speaker 16 may be dedicated to the system 10. Alternatively, the speaker 30 may be a general-purpose speaker that also performs other functions, such as warning of unbuckled seatbelts, door ajar conditions, and the like. The speaker 30 may be disposed anywhere within the vehicle 1, or even on the track 11.

As shown by the system 10, the track 11 may be as in the general form resembling the shape of a question mark so that as the mover 12 moves along the track 11, the caddy 13 passes by each passenger seat in the vehicle 1. Of course, it will be understood that other shapes for the track 11 may be employed that are best adapted to the layout of the vehicle 1 according to the location of the seats in the vehicle 1 and to avoid obstructions to the caddy 13; such obstructions may include, for example, installed video systems, lights or the like, and seat backs. For example, the track 11 may be U-shaped, passing along one side of the vehicle 1 and returning along another side of the vehicle 1, or along the middle of the vehicle 1. Alternatively, the track 11 may simply be a straight stretch running along one side of the vehicle 1, or down the approximate centerline of the vehicle 1. The track 11 may be made of steel, and in the system 10 may be incorporated into the interior vehicle 1 roofing assembly. However, it will be understood that other materials for the track 11 may be used, such as aluminum, plastic or the like. The track 11 may be installed such that the track 11 is flush with, or recessed within, roof liner 6 of the vehicle 1. Or, the track 11 may be mounted on the roof liner 6, or adjacent to the roof liner 6. Thus, it is also possible for the track 11 to protrude from the liner 6, which may occur if the system 10 is installed as an after market add-on, or if the roof is little more than a sheet (that is, the roof has no liner, and so the roof liner 6 is nothing more than the internal surface of the roof). However, such installations of the track 11 will reduce the amount of headroom available to passengers within the vehicle 1. The track 11 may be attached to the roof of the vehicle 1 by welding, or with fasteners such as bolts or screws. For purposes of the present invention, it will be understood that the track 11 encompasses not only rails along which the mover 12 may roll or slide, but also wires which may pull the mover 12 or provide a path for the mover 12 to traverse along; that is, the track 11 is used for defining the path within the vehicle 1 along which the mover 12 traverses.

The caddy 13 and mover 12 provide a transport for carrying items along a route defined by the path, while the user control 15 and control logic 16 are used for controlling the operations of the transport. Together, the transport and control enable passengers to move items throughout the vehicle 1 while the vehicle 1 is stationary or while in motion. For example, a family on the go may get food at a drive-through restaurant window. After the food is handed to the driver in seat 2, the driver can put the food, which is to be moved to the rear of the vehicle for the kids, on a center console 4. The front seat 3 passenger would then put the food and drinks into the caddy 13 and send the caddy 13 to stop 14b, back to the kids in a third row of seats 5 of the vehicle 1, by clicking on the user control 15. When the kids have finished their food, they would put the empty wrappers and cups in the caddy 13, and the front seat 3 passenger would click on the control 15 to send the caddy 13 to the stop 14a. Then, the front seat 3 passenger could remove the garbage and place it in a bag on the floor. As a result, by utilizing the system 10 when passing items back and forth between the front and rear of the vehicle 1 via stops 14a and 14b, none of the passengers in the vehicle 1 need to move from their respective seats 3, 5, nor do they need to unbuckle their seatbelts.

In the embodiment shown in FIG. 2, the caddy 13 is connected to the mover 12 to provide the transport. As shown in FIG. 2, the caddy 13 may be a bag, or a mesh. The caddy 13 may be provided a flap 25 that can be opened or closed along a seam 26. The flap 25 may be provided an appropriate fastener, such as Velcro, snaps, magnets or the like, to seal or close the flap 25 along the seam 26. Of course, other configurations are possible for the caddy 13, such as a plastic box, a tray with drink holders, one or more clips or clamps for holding objects, or any other configuration suitable for carrying items. The caddy 13 may be connected to the mover 12 via a detachable connector 17 so that a user may easily detach the caddy 13 from the mover 12. The detachable connector 17 may include, for example, a hook and eye or hook and hook combination, a carabiner or like device, snaps, buckles or any other suitable connecting mechanism.

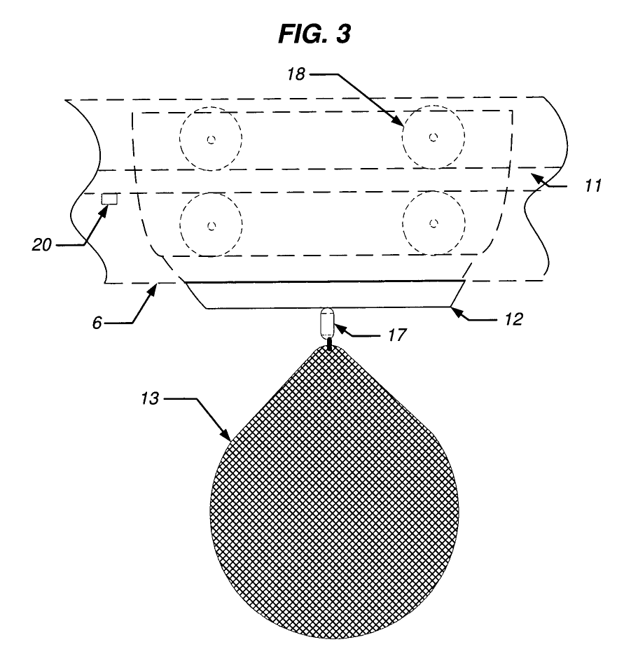

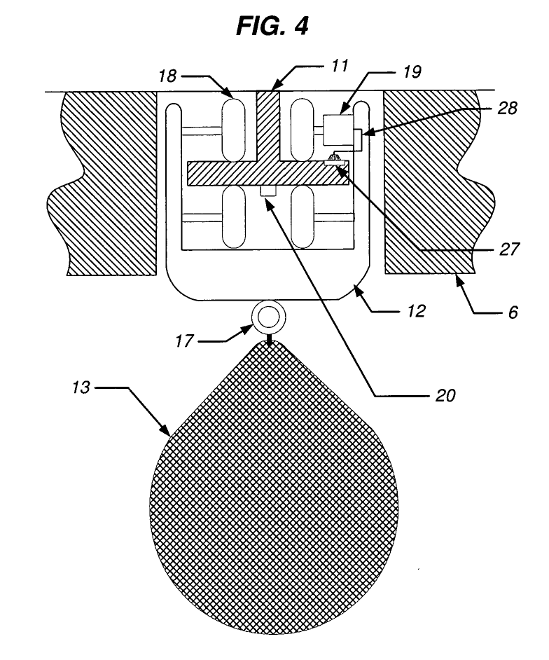

Referring now to FIG. 3 and FIG. 4, FIG. 3 shows a side view of a portion of the in-vehicle transport system 10, while FIG. 4 shows an end view of a portion of the system 10. The caddy 13 is connected to the mover 12 with the connector 17, which may be ring-shaped, or have any other suitable shape or configuration. The track 11 is recessed within the roof liner 6 of the vehicle 1, and as a result the mover 12 is nearly flush with the roof liner 6. Wheels 18 connect the mover 12 to the track 11. A locomotion device for the mover 12, which provides the motivating force that moves the mover 12 forward and backward along the track 11, may be hidden from the occupants of the vehicle 1 for aesthetic and safety reasons. For example, as shown in FIG. 4, at least one of the wheels 18 is powered by a motor 19, which serves as the locomotion device, disposed within the mover 12 that allows that mover 12 to roll along track 11. The track 11 may include a power strip 27 that provides electrical power for the motor 19. The mover 12 may be provided brushes or contacts 28 that make electrical contact with the power strip 27 to deliver the electrical power to the motor 19. By controlling the voltage or current present on the power strip 27, the control logic 16, or user control 15, can control both the speed and direction of travel of the mover 12. The wheels 18 may be made of rubber to provide sufficient grip on track 11, and to allow for noise-free motion. Design of the wiring between the control logic 16, the track 11 and the electrical system of the vehicle 1 should be routine for one with reasonable skill in the art.

Disposed at various positions along the route of track 11 (that is, along the route defined by the path) corresponding to the stops 14a-14c are stop indicators 20, which are used to detect the presence of the mover 12 at the corresponding position on the track 11. In the system 10, the stop indicators 20 may be active elements electrically connected to the control logic 16, thereby enabling the control logic 16 to detect and determine the location of the mover 12 and to control power on the power strip 27 to halt the mover 12 at one of the stops 14a-14c. Any suitable device may be used for the stop indicator 20, such as a contact switch that is activated by one of the wheels 18 or the body of the mover 12, a magnetic detector that senses a corresponding magnet on the mover 12, an LED/photo-sensor pair that is disrupted by the mover 12, etc.

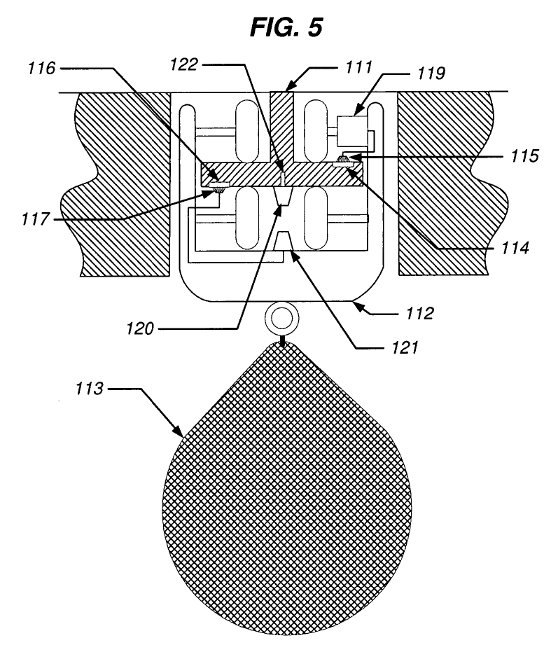

Referring now to FIG. 5, which is an end view illustrating a second embodiment of the present invention, as in the first embodiment system 10, a track 111 is disposed within the interior of a vehicle defining a path through the vehicle. A mover 112 transports a caddy 113 by moving along the track 111, powered by a motor 119, which obtains electrical power from a power strip 114 on the track 111 via brushes or contacts 115. Control logic (not shown), analogous to the control logic 16 of the system 10, can control the voltage or current on the power strip 114 to control the movement of the mover 112. However, in addition to the power strip 114, the track 111 also includes at least one signal strip 116 along which signals can be passed between the mover 112 and the control logic. As with the power strip 114, brushes or contacts 117 provide electrical connection between the mover 112 and the signal strip 116. In this embodiment, the mover 112 uses the signal strip 116 to send positioning signals to the control logic so that the control logic can determine the current location of the mover 112. As in the system 10, disposed at positions along the track 111 are one or more stop indicators 120. However, in this embodiment the stop indicators 120 may be passive elements, which are detected by a corresponding stop indicator sensor 121 on the mover 112. The stop indicator sensor 121 is electrically connected to the brush or contact 117 to send position signals along the signal line 116 to the control logic. The stop indicator sensor 121 may be, for example, a magnetic detector, an LED/photo-sensor pair or a mechanical switch. The stop indicator 120 could thus be a magnet for the magnetic detector, or a simple strip that disrupts the LED/photo-sensor pair or triggers the mechanical switch. This embodiment provides easily installed manufacturer, installer or user-definable stops along the track 111. For example, the track 111 may be provided a plurality of holes or slots 122 along its length into which a user may insert the stop indicator 120 at a desired position. When the stop indicator sensor 121 senses the user-installed stop indicator 120, the stop indicator sensor 121 sends a signal via the signal strip 116 to the control logic, which then may adjust the voltage or current on the power strip 114 to cause the mover 112 to stop.

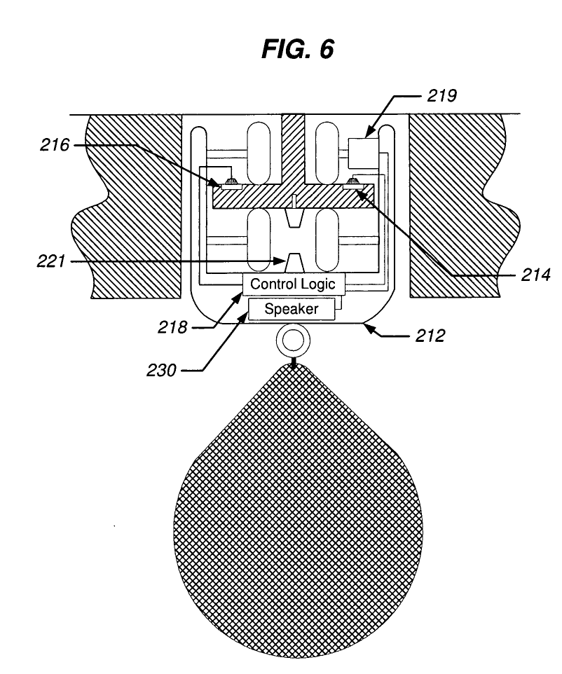

Referring now to FIG. 6, this embodiment is similar to the second embodiment, except that the signal strip 216 is used to communicate signals from the user control (not shown) to the mover 212. In this embodiment, the control logic 218 is disposed within the mover 212. Hence, the control logic 218 obtains power from the power strip 214, and controls the motor 219 based upon user control signals obtained from the signal strip 216 and position information obtained from the stop indicator sensor 221. The speaker 230 may also be disposed on the mover 212, and controlled by the control logic 218.

By providing a signal strip on the track, it is possible for the control logic to obtain information about the status of the motor; either directly, as in the third embodiment, or via the signaling strip, as in the second embodiment. Consequently, when the motor comes under strain, as when blocked by a person or an obstruction, or upon reaching the ends of the track, a corresponding signal may be sent to the control logic, in response to which the control logic can turn off the motor, or perform any other appropriate action, such as resetting the apparent location of the mover. Of course, means other than a signal strip on the track may be used to transmit signaling information between the mover and the control logic, or between the control logic and the user controls; for example, retractable or flexible wires may be used, or even a wireless communications link. Means for transmitting signaling information between two points (i.e., the mover and the control logic) are well known in the art, and any such suitable means may be employed for the purposes of the present invention. Also, it should be understood that it is possible to dispose a portion of the control logic on the mover, and another portion of the control logic off the mover. For example, a sub-set of the control logic for performing collision detection could be mounted on the mover; the mover could thus detect collision or end-of-track conditions autonomously, while another sub-set of the control logic for scheduling and handling stops could be disposed off of the mover and control the mover via a signal line or power line.

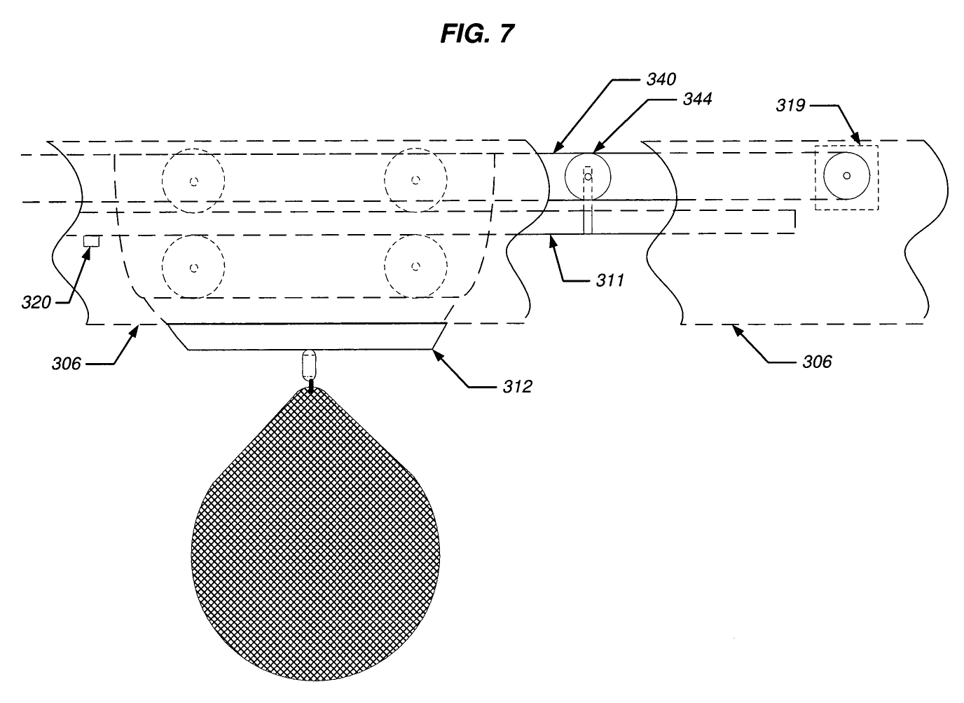

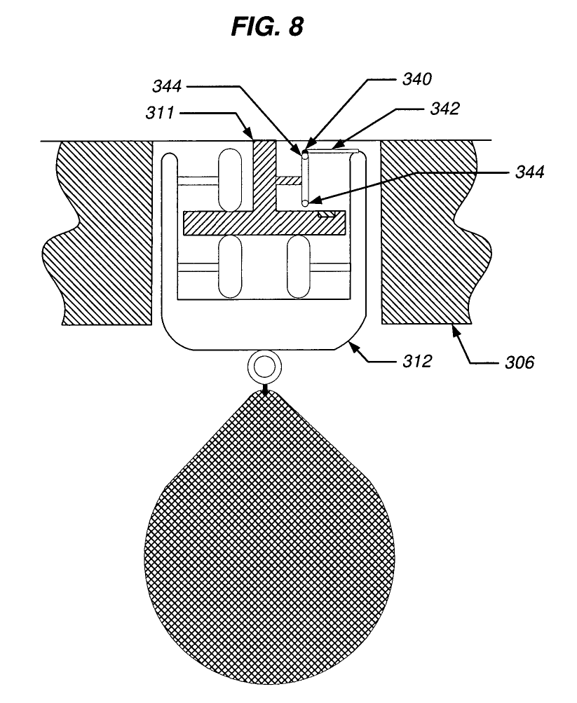

The locomotion device for the mover need not be disposed on the mover; other configurations to motivate the mover are certainly possible and within the scope of the present invention. For example, referring now to FIG. 7 and FIG. 8, according to a fourth embodiment, a cable-car system is used to drive the mover 312 along a rail 311. The motor 319 is mounted in the vehicle roof liner 306, thus stationary with respect to the vehicle body, and drives a continuous loop 340 that runs along the rail 311. Support pulleys 344 may also be disposed along or adjacent to the rail 311 to guide and support the continuous loop 340. The continuous loop 340, rail 311 and pulleys 344 define the path in this embodiment. The mover 312 includes an arm 342 that connects to the continuous loop 340 so that the continuous loop 340 may pull the mover 312 along the path. As in the previous embodiments, one or more stop indicators 320 may be disposed along the path to provide location detection of the mover 312, and indicate where the mover 312 should be stopped. If necessary or desired, power and/or signal strips may be provided on, or adjacent to, the rail 311 as previously described to respectively provide power and/or signal connections to the mover 312.

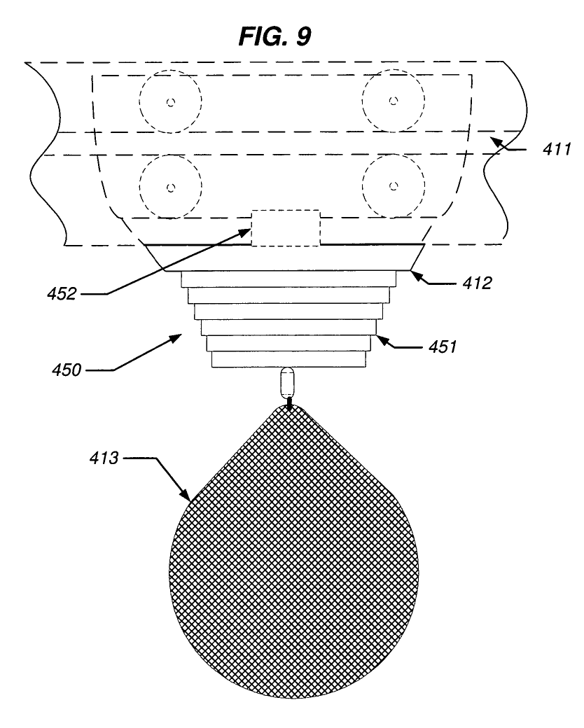

Referring to FIG. 9, which is a side view of a transport provided by a mover 412 and caddy 413 according to a fifth embodiment of the present invention, the mover 412 may be provided an extension 450 to extend and retract the caddy 413. While the mover 412 is in motion, the extension 450 may retract so that the caddy 413 passes freely over obstructions, such as seat backs. When the mover 412 reaches its desired stop, the extension 450 may automatically or manually extend so that the caddy 413 lowers and thus is more easily reached by the intended recipient of items held by the caddy 413. The extension 450 may be remotely retracted or extended from the user control, or optionally via the control logic.

Having the control logic control the extension 450 allows the control logic to prevent the extension 450 from extending while the caddy 413 is in motion. Alternatively, this configuration can have the extension 450 automatically extend without human intervention when the caddy 413 arrives at its stop, and automatically retract before the caddy 413 begins moving to the next stop. As shown in FIG. 9, the extension 450 may include a telescoping mechanism 451 and driving motor 452, which can be selected by the skilled artisan.

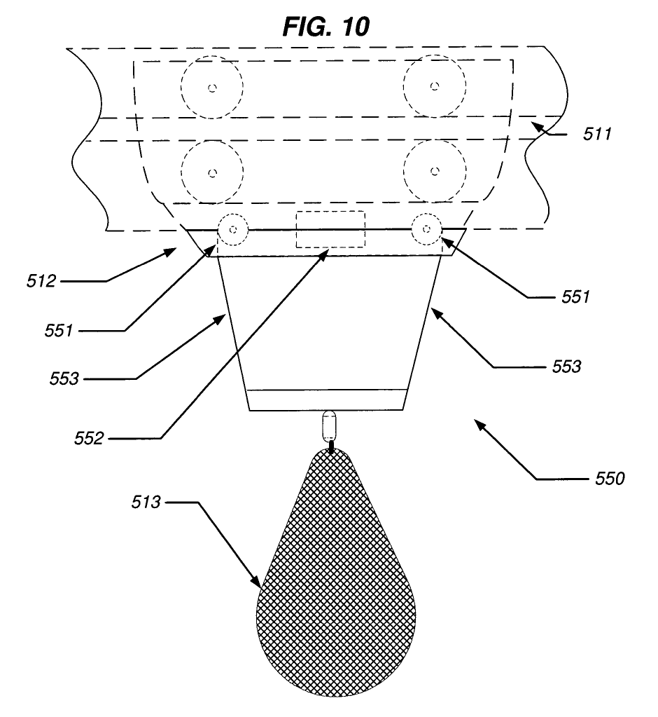

As shown in FIG. 10 depicting a sixth embodiment, the extension 550 may be a crane system that includes one or more spools 551 for reeling in and reeling out line 553, and a driving motor 552 for rotating the spools 551. More than one line 553 may be provided to provide some stability to the caddy 513 when being reeled up towards the mover 512. As disclosed above, both power and signal may be provided by the track 411, 511 to power and control the driving motor 452, 552. Alternatively, it will be understood that the motor 552 is not required. Instead, the spool or spools 551 may be biased by a torque spring, in a manner familiar to those in the art, so that the spool or spools 551 tend to reel in or reel out the line 553 depending upon the tension placed upon the line 553.

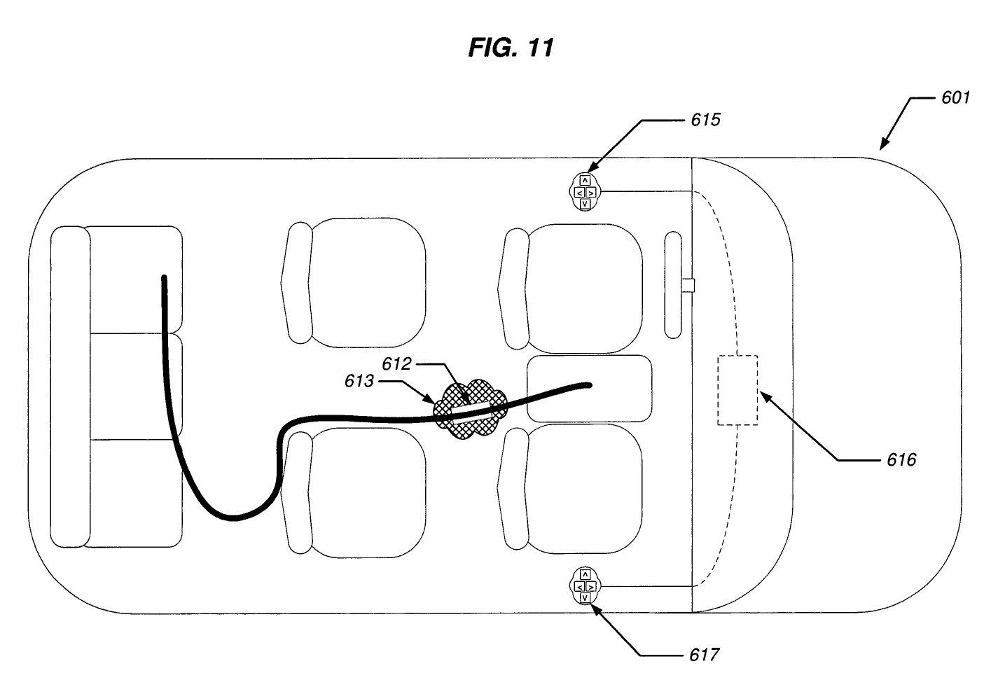

Of course, the present invention is not limited to a single set of user controls. Multiple user controls may be provided so that multiple passengers may use the in-vehicle transportation system of the present invention. For example, referring to FIG. 11, which depicts a top view of a seventh embodiment, a vehicle 601 is outfitted with two user controls: a driver-side user control 615, and a passenger-side user control 617. Each user control 615, 617 is a four-way rocker switch, which sends commands to control logic 616 to control movement of the mover 612, and to the extension on the mover 612 to raise and lower the caddy 613. Moving the rocker switch 615, 617 forward causes the mover 612 to advance towards the front of the vehicle 601 along the path, while moving the rocker switch 615, 617 back causes the mover 612 to move back along the path towards the rear of the vehicle 601. Moving the rocker switch 615, 617 to the left causes the caddy 613 to descend, and moving the rocker switch 615, 617 to the right causes the caddy 613 to ascend. Where there are command conflicts between the user control 615 and 617, the control logic 616 may selectively prefer commands received from the driver-side user control 615.

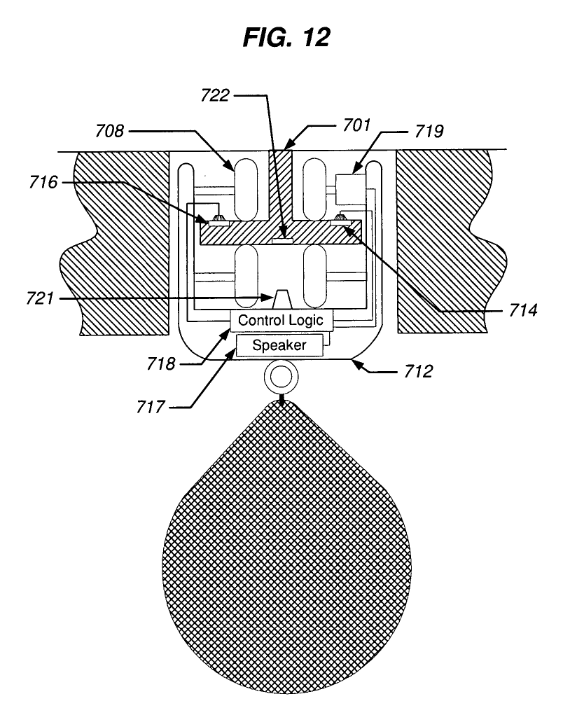

The present invention does not require that the stops be physically located on the track or path. If the mover is provided the ability to determine its position along the path, then it is possible to implement the stops in software within the control logic, and to permit the user to program the control logic so as to change the default number and position of the stops along the path. Such an embodiment is exemplified in FIG. 12, in which a mover 712 is provided control logic 718 that is electrically connected to a motor 719, a power strip 714 and a signal strip 716. The control logic 718 receives user control signals from the signal strip 716, and power from the power strip 714, which power the control logic 718 may use to control the motor 719. The control logic 718 also receives position signals from a position sensor 721 that is used to determine the position of the mover 712 along the track 701. The position sensor 721 could be, for example, an optical sensor for reading an optically encoded strip 722 that runs along the path defined by the track 701. However, any other means for determining the position of the mover 712 are certainly possible, such as using a sensor that detects the revolutions of one of the wheels 708 and sends a corresponding signal to the control logic 718, which can then compute how far forward or backwards along the track 701 the mover 712 has advanced; this would be an example of the control logic 718 actually incorporating a portion of the position sensor 721. Other possibilities for the position sensor 721 include magnetic encoding and detection along regions of the track 701, distance computation based upon motor 719 activation and duration of such activation, or the like. Position sensing and detection is a well developed field, and any known method may be used.

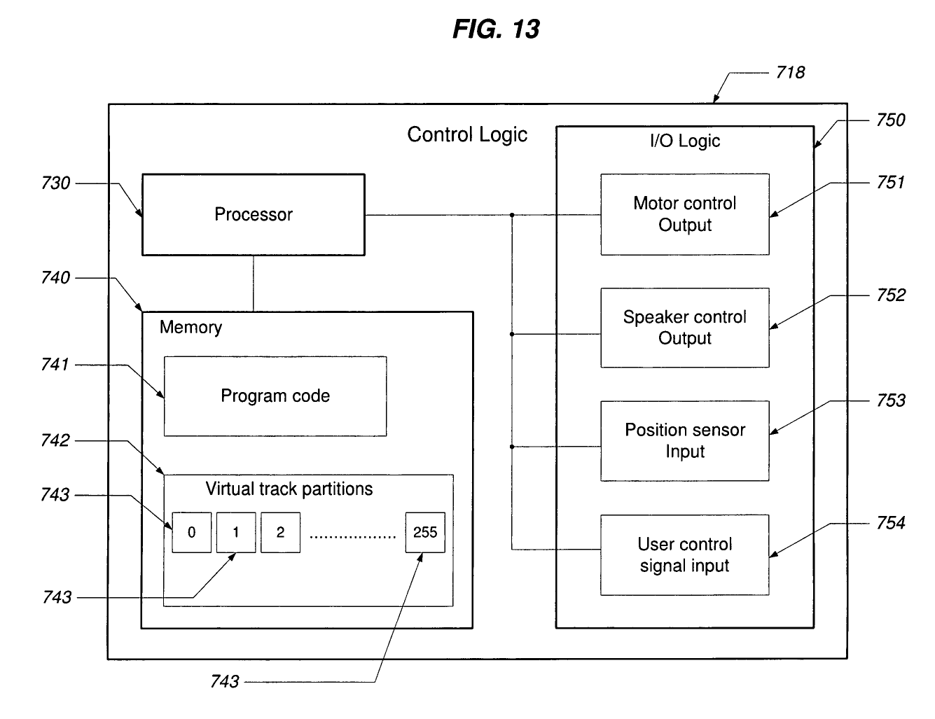

In any event, by learning of the current position of the mover 712 from the position sensor 721, the control logic 718 can control the motor 719 to stop at pre-programmed positions along the track 701 as indicated by user control signals obtained from the signal strip 716. An illustrative embodiment for the control logic 718 is presented in FIG. 13. The control logic 718 may include a processor 730 in electrical communications with memory 740 and input/output (I/O) logic 750. The I/O logic 750 includes a motor control output 751 that enables the processor 730 to control the direction, and optionally the speed, of the motor 719; a speaker control output 752 that enables the processor 730 to generate audible tones via the speaker 717; a position sensor input 753 which enables the processor 730 to receive position information signals from the position sensor 721 and thus determine the current position of the mover 712 along the track 701, and a user control signal input 754 that enables the processor 730 to learn of the user signals generated by a user activating the user controls (not shown) as received from the signal strip 716. The memory 740 includes program code 741 that is executed by the processor 730 to control the overall operations of the processor 730, and a database of virtual track partitions 742. The virtual track partitions 742 represent a finite number of partitions along the length of the track 701; these partitions may be of equal length, though this is not required. As shown in the embodiment, the track 701 may be divided into 255 virtual track partitions; of course, a lesser or greater number of partitions may be used. Each virtual track partition is assigned a bit 743, with one state of the bit 743 (e.g., a zero) indicating no stop at the length in the track 701 corresponding to the virtual track partition, and another state of the bit 743 (e.g., a one) indicating a stop at that length in the track 701. As the mover 712 progresses along the track 701, the position sensor 721 generates corresponding position signals, which the processor 730 receives from the position sensor input 753. The processor 730 uses the position signals to index into the virtual track partitions 742 and retrieve the bit 743 corresponding to the current position of the mover 712. If the bit 743 is a one, and the user control signals from the signal strip 716 have not indicated that this stop should be skipped, the processor 730 sends out signals via the motor control output 751 to cause the motor 719 to stop.

With an appropriate implementation of a user interface for the user controls, such implementations being well known in the art, the processor 730 may receive user control signals to set and reset the bits 743, and hence set and clear as many stops along the path defined by the track 701 as there are virtual track partitions 742. Additionally, it is certainly possible to provide more than one database of virtual track partitions 742, which may be selectively used by the processor 730, so that a user may easily and quickly switch between various stop configurations. For example, one configuration may have only two stops, whereas a second configuration could have six stops. These configurations could be stored in the memory 740, and the processor 730 could switch between them based upon user control signals obtained from the user control signal input 754. Thus, the processor 730, memory 740 and position sensor 721 form a stop indicating system that is used to determine where along the path the mover 712 should stop. Similarly, the processor 730, memory 740 and signal strip 716 form the control system that is used to control the motor 719.

Although embodiments of the invention herein has been described with reference to particular embodiments, it is to be understood that these embodiments are merely illustrative of the principles and applications of the present invention. It will be apparent to those skilled in the art that various modifications and variations can be made to the method of the present invention without departing from the spirit and scope of the invention. For example, although the embodiments disclosed above show the mover and caddy as separate items, it will be understood that the mover and caddy could be a single, integrated object. Moreover, the user control and the control logic need not be separate items. In a simple embodiment, the control logic could be omitted entirely, and the mover would simply move as dictated by the user control; that is, the control signal sent by the user control would directly control the motor that urges the mover along the path, and optionally control the motor that drives the extension. Similarly, although the various embodiments disclose a mover that is powered by a motor, a manually actuated mover, such as with a crank or simply by pushing the mover along the track, and with optional attendant mechanical stops, is within the scope of the present invention. Thus, it is intended that the present invention include modifications and variations that are within the scope of the appended claims and their equivalents.

1. An in-vehicle transportation system comprising:
a track defining a path accessible by passengers at different locations inside the vehicle including a roof, the track running along or adjacent to the roof of the vehicle;
a mover movably associated with the track; and
a caddy coupled to the mover for carrying an item to one or more of the passengers.

2. The system of claim 1 further comprising:
a motor for driving the mover along the track; and
a user control for generating a user control signal to control the motor.

3. The system of claim 2 further comprising control logic, the control logic controlling the motor according to the user control signal and a position information signal generated by the mover moving along the track.

4. The system of claim 3 wherein the track further comprises a stop indicator disposed along the track for generating a corresponding position information signal when the mover reaches a predetermined position on the track.

5. The system of claim 4 wherein the control logic controls the motor to stop the mover when the corresponding position information signal is received by the control logic.

6. The system of claim 4 wherein the stop indicator is electrically connected to the control logic.

7. The system of claim 4 further comprising a signal line electrically connecting the control logic with a stop indictor sensor disposed on the mover, wherein the stop indicator sensor is capable of detecting the stop indicator and in response generating the position information signal, and is further capable of causing the position information signal to be sent to the control logic through the signal line.

8. The system of claim 7 wherein the stop indicator is not electrically connected to the control logic.

9. The system of claim 7 wherein the track further comprises a plurality of slots adapted to accept the stop indicator.

10. The system of claim 3 further comprising a speaker electrically connected to the control logic; wherein the control logic causes the speaker to generate a first audible signal if the control logic is unable to fulfill a command received from the user control.

11. The system of claim 10 wherein the control logic causes the speaker to generate a second audible signal when a position information signal is received indicating a successfully completed command received from the user control.

12. The system of claim 3 wherein the control logic comprises a memory for storing at least a stop location, and receives the position information signal to stop the mover at a position along the track corresponding to the stop location.

13. The system of claim 2 wherein the motor is disposed on the mover.

14. The system of claim 13 further comprising a power line for providing electrical power to the motor.

15. The system of claim 14 wherein the motor is controlled by controlling the current or voltage provided on the power line.

16. The system of claim 2 wherein the motor is fixed stationary to the vehicle body.

17. The system of claim 1 further comprising an extension for providing retractable extension of the caddy with respect to the mover.

18. The system of claim 2 further comprising an extension for providing retractable extension of the caddy with respect to the mover, wherein extension and retraction of the extension is controllable by the user control.

19. The system of claim 18 further comprising a connector for detachably connecting the caddy to the extension.

20. The system of claim 1 wherein the track is generally U- shaped or question mark-shaped.

21. The system of claim 1 further comprising a connector for detachably connecting the caddy to the mover.

22. An in-vehicle transportation system comprising:
means for defining a path accessible by passengers at different locations inside the vehicle, the path running along or adjacent to a headliner of the vehicle; and
a transport means for carrying an item along the path, the transport means coupled to the means for defining a path.

23. The system of claim 22 further comprising:
locomotion means for providing a motivating force to the transport means to move the item along the path; and
control means for controlling the locomotion means.

24. The system of claim 22 wherein the transport means comprises an extension means for raising and lowering the item.

25. The system of claim 23 further comprising stop indicating means for indicating positions along the path at which the transportation means stops.

26. The system of claim 25 further comprising signal transmission means for transmitting signaling information between the transport means and the control means.

27. A method for transporting an object between passengers within a vehicle, the method comprising:
placing the object within a caddy that is mechanically coupled with a track located along or adjacent to a vehicle roof;
moving the caddy along the track between the passengers; and
removing the object from the caddy.

28. The method of claim 27 further comprising lowering the caddy prior to removing the object.

29. The method of claim 27 wherein a motor causes the caddy to move along the track.
